(19) United States
(12) Patent Application Publication
(10) Pub. No.: US 2007/0042244 A1
(43) Pub. Date: Feb. 22, 2007

(54) Hybrid hydrogen fuel systems and methods

(76) Inventors: John Spallone, Danbury, CT (US); Ian Eason, Hillsborough, NJ (US); Richard M. Mohring, East Brunswick, NJ (US); Keith A. Fennimore, Columbus, NJ (US); Michael T. Kelly, Plainsboro, NJ (US)

Correspondence Address: DICKSTEIN SHAPIRO LLP, 1825 EYE STREET NW, Washington, DC, 20006-5403, US

(21) Appl. No.: 11/505,828

(22) Filed: Aug. 18, 2006

Related U.S. Application Data
(60) Provisional application No. 60/709,449, filed on Aug. 19, 2005.

(51) Int. Cl. H01M 8/04; H01M 8/06; H01M 16/00

(52) U.S. Cl. 429/22; 429/19; 429/9

(57) ABSTRACT

Hybrid systems and methods for managing hydrogen system pressure and providing continuous electrical power during startup and hydrogen flow transients in an electrical power system are disclosed. The hybrid systems of the present invention comprise a hydrogen gas generator, an electricity producing hydrogen consuming device, and an auxiliary power source wherein the auxiliary power source is capable of storing energy produced by hydrogen produced by the generator, and the electricity producing hydrogen consuming device and the auxiliary power source are connected in parallel to an energy consuming device.

### CROSS-REFERENCE TO RELATED APPLICATIONS

This application claims the benefit of U.S. Provisional Application Ser. No. 60/709,449, filed Aug. 19, 2005, the entire disclosure of which is incorporated herein by reference.

### FIELD OF THE INVENTION

The invention relates to hybrid hydrogen fuel systems, fuel cell power systems and control methods. More particularly, the invention relates to systems and methods for monitoring and controlling hydrogen generation and hydrogen system pressure in hybrid hydrogen fuel and power systems.

### BACKGROUND OF THE INVENTION

Hybrid power systems typically comprise a fuel cell and battery and are preferred for certain power applications, such as, for example, electronic devices that may be turned on and off frequently. In these systems, the fuel cell can provide the primary electrical power to the device and can charge the battery as well. The battery can provide power during system startup, typically when the hydrogen generator and fuel cell are not yet at their ideal operating state, and also can provide power to the device to compensate for peaks in the load. In such systems, the fuel cell power system is used to charge a battery which is the power source.

### BRIEF SUMMARY OF THE INVENTION

The present invention provides in preferred embodiments a system for generating electrical power utilizing hydrolysis of boron hydride compounds to generate hydrogen gas. The system of the present invention comprises a hydrogen consuming device such as a fuel cell or the like to generate electrical power from the hydrogen gas, an auxiliary power system (preferably selected from the group comprising a rechargeable battery, a capacitor, and a supercapacitor) to provide continuous electrical power during startup and hydrogen flow transients, and one or more devices to monitor and/or control the process and charge state of the auxiliary power system. The auxiliary power system may also be used to store electrical energy generated by the fuel cell from the excess hydrogen gas that is produced by a hydrogen generator when a load is removed. The power systems of the present invention are applicable to any hydrogen source, including, but not limited to, those sources exhibiting excess hydrogen production after shutdown.

The present invention also provides methods for controlling and monitoring hydrogen generation in power systems. According to one embodiment of the present invention, energy is provided as electrons which can be supplied alternately from a hydrogen consuming device or from an auxiliary power system, which may be connected in parallel directly, or indirectly (such as through a power conditioner), to an energy consuming electronic device. According to another embodiment of the present invention, the state of charge of the auxiliary power system may be used to regulate and control the hydrogen gas generator. In yet another embodiment, the auxiliary power system comprises a rechargeable battery and the rate of charge of the rechargeable battery is varied to manage the hydrogen pressure of the power system. Alternatively, a capacitive element may be optionally used in conjunction with the rechargeable battery to reduce, for example, pressure peaks and to improve response to pulse electrical loads.

### BRIEF DESCRIPTION OF THE DRAWINGS

A complete understanding of the present invention may be obtained by reference to the accompanying drawings when considered in conjunction with the following detailed description, in which:

FIG. 1 is a diagram of a hybrid fuel cell power system useful in an embodiment of the present invention;

FIG. 2 is a schematic diagram of electrical power output in one mode of a hybrid fuel cell power system in accordance with an embodiment of the present invention;

FIG. 3 is a schematic diagram of electrical power output in one mode of a hybrid fuel cell power system in accordance with another embodiment of the present invention;

FIG. 4 is a schematic diagram of a hybrid fuel cell power system in accordance with another embodiment of the present invention;

FIG. 5 is a schematic diagram of a hybrid hydrogen fuel system according to another embodiment of the present invention; and

FIG. 6 is a schematic diagram of the hydrogen generator of the fuel system of FIG. 5.

### DETAILED DESCRIPTION OF THE INVENTION

The hybrid systems and control methods of the present invention are suitable for managing hydrogen system pressure and for providing continuous electrical power during hydrogen flow transients in an electrical power system, including systems comprising a hydrogen gas generator, a hydrogen consuming device such as a fuel cell or the like, and an auxiliary power system. By “hybrid” herein we mean that the system or method includes a power producing hydrogen consuming device and an auxiliary power system, which may be a rechargeable battery, a capacitor or the like capable of storing electrons.

Suitable hydrogen gas generators include, for example, systems based on hydrolysis, alcoholysis, or ammonolysis of chemical hydrides. These “lysis” systems may be accelerated or initiated by a heterogeneous or homogeneous transition metal catalyst, adds, or heat. Exemplary gas generators include those based on the transition metal catalyzed hydrolysis of solutions of boron hydrides, acid promoted hydrolysis of water and chemical hydrides, and thermally initiated hydrogen generation reactions of chemical hydrides.

Suitable chemical hydrides include, but are not limited to, boron hydrides, ionic hydride salts, and aluminum hydrides. The chemical hydrides may be utilized in mixtures or individually.

Suitable boron hydrides include, without intended limitation, the group of borohydride salts [M(BH₄)ₙ], triborohydride salts [M (B₃H₈)ₙ], decahydrodecaborate salts [M(B₁₀H₁₀)ₙ], tridecahydrodecaborate salts [M(B₁₀H₃)ₙ], dodecahydrododecaborate salts [M₂(B₁₂H₁₂)ₙ], and octadecahydroicosaborate salts [M₂(B₂₀H₈)ₙ], where M is an alkali metal cation, alkaline earth metal cation, aluminum cation, zinc cation, or ammonium cation, and n is equal to the charge of the cation; and neutral borane compounds, such as the group of polyhedral boranes including decaborane(14) (B₁₀H₁₄); ammonia borane compounds of formula NHₓBH_{y}, wherein x and y are independently an integer from 1 to 4 and do not have to be the same, and NHₓRBH_{y}, wherein x and y are independently an integer from 1 to 4 and do not have to be the same, and R is a methyl or ethyl group.

Ionic hydrides include, without intended limitation, the hydrides of alkali metals and alkaline earth metals such as lithium hydride, sodium hydride, magnesium hydride, and calcium hydride and having the general formula MHₙ wherein M is an alkali metal or alkaline earth metal cation, and n is equal to the charge of the cation.

Aluminum hydrides include, for example, alane (AlH₂) and the complex aluminum hydride salts including, without intended limitation, salts with the general formula M(AlH₄)ₙ, where M is an alkali metal cation, alkaline earth metal cation, aluminum cation, zinc cation, or ammonium cation, and n is equal to the charge of the cation.

Suitable auxiliary power systems include, for example, electrical storage devices such as rechargeable batteries and capacitors.

Suitable hydrogen consuming devices that generate electrical power from hydrogen gas include, for example, fuel cells and hydrogen combustion engines combined with at least one electrical generating coil.

The present invention provides systems and control methods to manage the hydrogen gas produced by a hydrogen generator to control, for example, the hydrogen pressure of an electrical power system within the design limits of the components and/or to provide consistent electrical output. Efficient utilization of hydrogen increases overall energy storage density as stored hydrogen is not wasted and pressure control allows components such as the fuel cell and hydrogen generator enclosures to be fabricated from thin and lightweight materials.

Notably, the preferred systems of the present invention include a parallel design in which energy as electrons can be supplied alternately from the hydrogen consuming device or the auxiliary power system. Further, in preferred methods according to the present invention, the state of charge of the auxiliary power system can be used to regulate and control the hydrogen gas generator.

One embodiment of the present invention provides systems and control methods to vary the rate of charge of a rechargeable battery to manage the hydrogen pressure of the electrical power system. A capacitor or super capacitor may optionally be used in conjunction with the rechargeable battery to reduce, for example, pressure peaks and to improve response to pulse electrical loads.

In one embodiment, the hydrogen gas generator is a system that generates hydrogen gas by the reaction of solid chemical hydrides with an acidic reagent as disclosed in co-pending U.S. patent application Ser. No. 11/105,549, filed Apr. 14, 2005, the disclosure of which is incorporated by reference herein in its entirety. However, any suitable hydrogen gas generator may be used, and may be selected by one of ordinary skill in the art given the teachings herein. The hydrogen gas produced in this fashion may be supplied to a fuel cell or the like (such as, for example, a hydrogen burning engine) to generate electrical power.

The hydrogen gas generator can use a pump or pressure differential to feed a liquid acidic reagent to contact a solid chemical hydride. The rate of hydrogen generation may vary as the reactants are consumed, due to the nature and species of byproducts formed which may introduce convections, absorption and other inefficiencies in transport of the acidic reagent through the solid material. Overall, the hydrogen generation reaction also typically requires some time to both start and stop. More specifically, once the feed of the acidic reagent has stopped, the hydrogen generating system may continue to produce hydrogen for a time due to unreacted acidic reagent that is present in the reactor and in contact with the solid hydride. The excess hydrogen gas may be consumed by the fuel cell, vented from the system, or stored in a pressure vessel to avoid pressure buildup within the power system. Venting the hydrogen, however, may not be desirable from a safety or regulatory perspective. Storage of the hydrogen under pressure also would require additional components, adding cost and reducing overall energy storage density. The methods and control systems of this invention can overcome these problems by actively managing, for example, the charge state of the battery of the auxiliary power system to ensure that sufficient energy storage capacity is maintained to absorb the excess hydrogen generated during and/or after shutdown and by generating electricity from the excess hydrogen for storage in the battery.

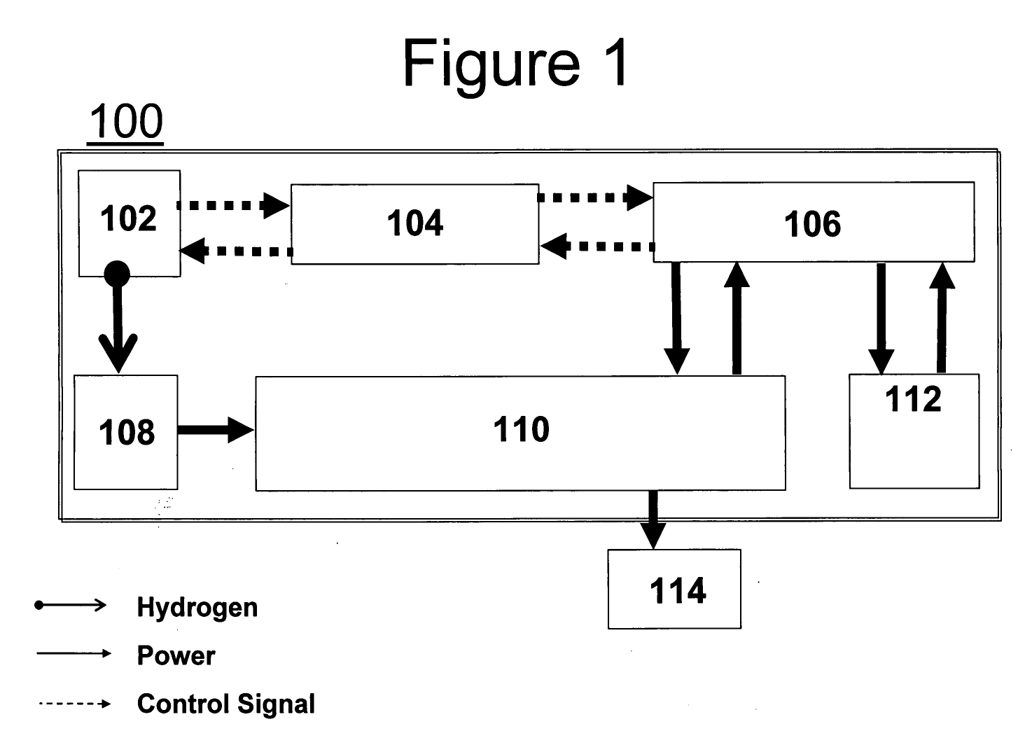

As shown in FIG. 1, an exemplary hybrid power system 100 according to this embodiment comprises a hydrogen generator 102, a hydrogen generator controller 104, a battery charging controller 106, a fuel cell 108, a power conditioner 110, and can include at least one sensor to measure system parameters such as hydrogen system pressure. Typical controllers include microcontrollers, microprocessors, and/or various electronic feedback and control systems that can perform mathematical and logic operations. Typical power conditioners include, for example, dc/dc converters, dc/ac converters, and voltage regulators. The power system 100 may be connected to an electronic device 114. In addition to controlling the hydrogen generator, controller 104 also communicates with charging controller 106 and provides information on the amount of battery capacity required to accommodate the hydrogen gas generated during shutdown. In addition to managing the state of charge, charging controller 106 communicates to controller 104 the hydrogen flow requirement to maintain the requested state of charge. Hydrogen gas is supplied by the hydrogen generator 102 to the fuel cell 108 for conversion to electrical power. A power conditioner 110 can be included in the power system to provide a constant voltage output. Battery 112 is also in electrical communication with the power conditioner 110 via charging control 106. The communication pathways and connections are illustrated in FIG. 1 for hydrogen (e.g., between hydrogen generation 102 and fuel cell 108), control signals (e.g., between 102, 104, and 106), and electrical power (e.g., between 106, 108, 110, 112, and 114).

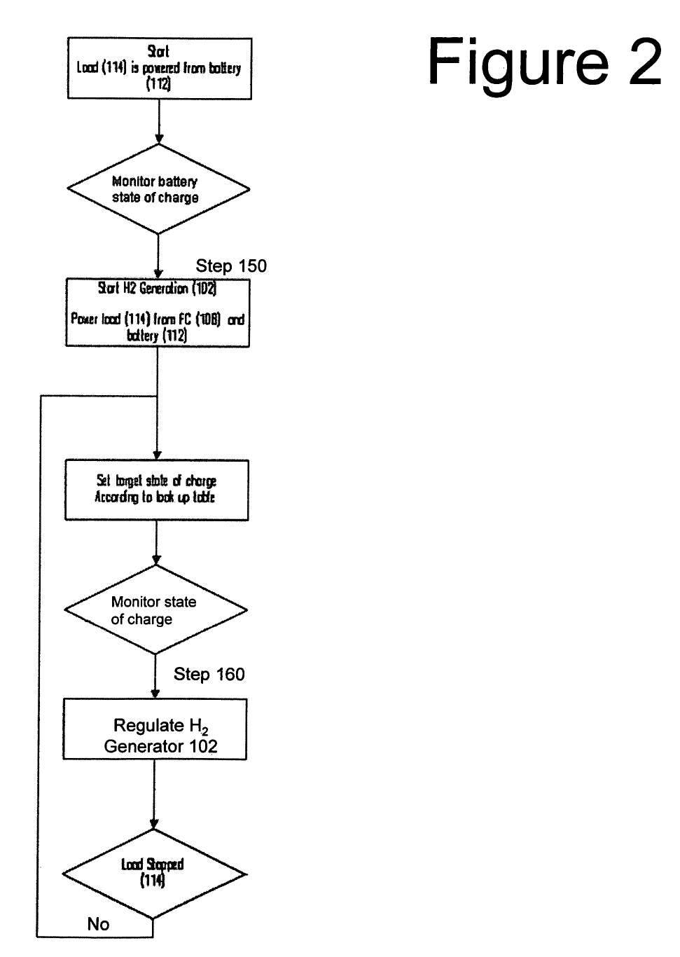

Upon initial start, for example, the battery 112 provides the power for the electronic device 114 as illustrated in FIG. 2. The battery state of charge is monitored and once the battery discharges to reach a preset state of charge, charging controller 106 provides a signal to the hydrogen generator 102 via controller 104 to begin hydrogen generation as provided at Step 150. When hydrogen is produced and supplied to the fuel cell 108 for conversion to electrical power, the fuel cell may provide the primary power to operate the electronic device. The battery is also available to provide power to handle peak loads for short durations and/or to absorb pressure transients due to excess hydrogen generation. For example, monitoring the system pressure indicates when the hydrogen generator 102 is producing sufficient hydrogen for the fuel cell to produce power to manage the applied load and to recharge the battery 112. The controller can signal the charging circuit to recharge the battery 112 whenever the system pressure exceeds a set point, such as may occur when the electronic device 114 is drawing low power and the fuel cell is consuming less hydrogen than the hydrogen generator 102 is producing.

A control algorithm identifies a target state of charge for the battery. For example, the state of charge may range from between about 20% to about 90% of the battery capacity. The target state of charge can be related to the run time, temperature, or pressure of the system wherein the amount of excess hydrogen is predictable and dependent on these factors. An exemplary look up table for state of charge is shown in Table 1 below.

TABLE 1
Exemplary Look Up Table (LUT)

| Runtime (minutes) | State of Charge (%) |
|---|---|
| 10 | 85 |
| 20 | 70 |
| 40 | 60 |
| 60 | 40 |
| 80 | 70 |

Monitoring the state of charge is used to control the hydrogen generator 102. When the state of charge exceeds the target range, the hydrogen generator 102 can be signaled to shut down at Step 160, and the battery can provide the primary power for the electrical load. The battery is then discharged to reach a state of charge of the battery below the target range, and the hydrogen generator is signaled to operate again. Monitoring the state of charge can also signal a problem with the hydrogen generator, if, for instance, the battery has been providing primary power due to a problem with the hydrogen generator 102 and/or the hydrogen consuming device. The power system can be signaled to alert the user, to run a self-diagnostic suite, and/or restart the hydrogen generator.

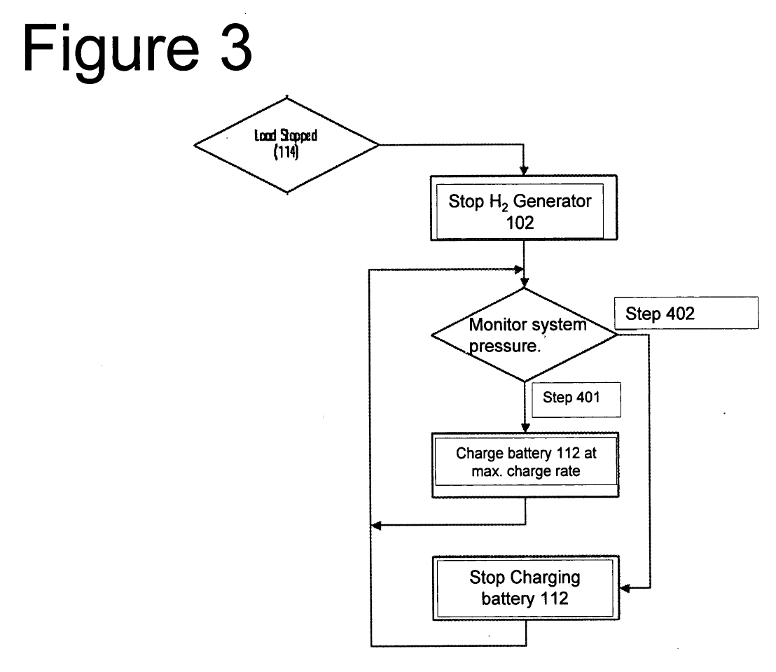

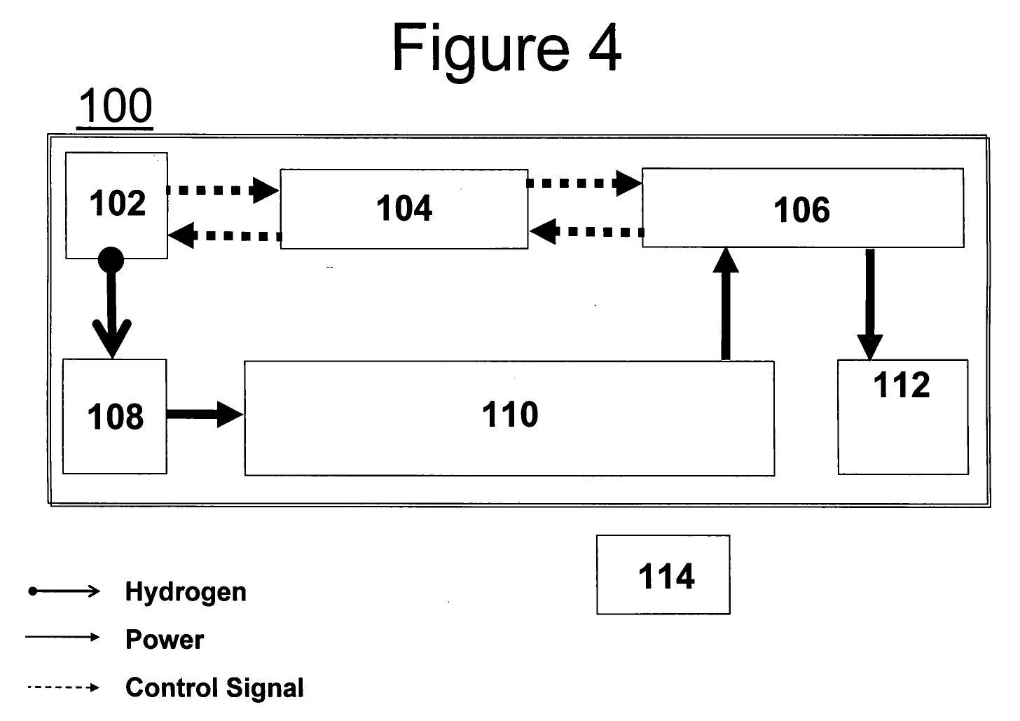

When the electronic device 114 is switched off and is no longer drawing electrical power from the fuel cell 108, the hydrogen generator 102 can be signaled to shut down. As discussed, hydrogen generation 102 may continue for a time after terminating the active reaction. The system pressure is monitored to ensure that it does not exceed the design limits. Referring now to FIG. 3, if the system pressure exceeds the set value, the fuel cell 108 can convert this hydrogen to electricity which can be used to re-charge the battery 112 (Step 401). When the system pressure is within the system design limits, the fuel cell is signaled to shut down and stop charging the battery (Step 402). The battery thus provides a hydrogen sink by allowing the excess hydrogen to be converted to electrical power which can be stored in the battery as shown, for example, in FIG. 4, using a power conditioner 110 and battery charging controller 106.

According to another embodiment, the hydrogen gas generator is a system that generates hydrogen gas by the thermal reaction of solid chemical hydrides such as, for example, the thermally initiated reaction of chemical hydrides with a water source, as disclosed in co-pending U.S. patent application Ser. No. 60/748,598, filed Dec. 9, 2005, the disclosure of which is incorporated by reference herein in its entirety, or the thermal decomposition of chemical hydrides such as, for example, ammonia boranes, lithium borohydride, or lithium aluminum hydride. However, any suitable hydrogen gas generator may be used, and may be selected by one of ordinary skill in the art given the teachings herein. The hydrogen gas produced in this manner may be supplied to a fuel cell or the like (such as, for example, a hydrogen burning engine) to generate electrical power. Such systems can operate in a batch mode in which an individual charge of the hydrogen storage fuel is completely discharged, and hydrogen gas may be generated at a rate faster than the hydrogen device can consume it.

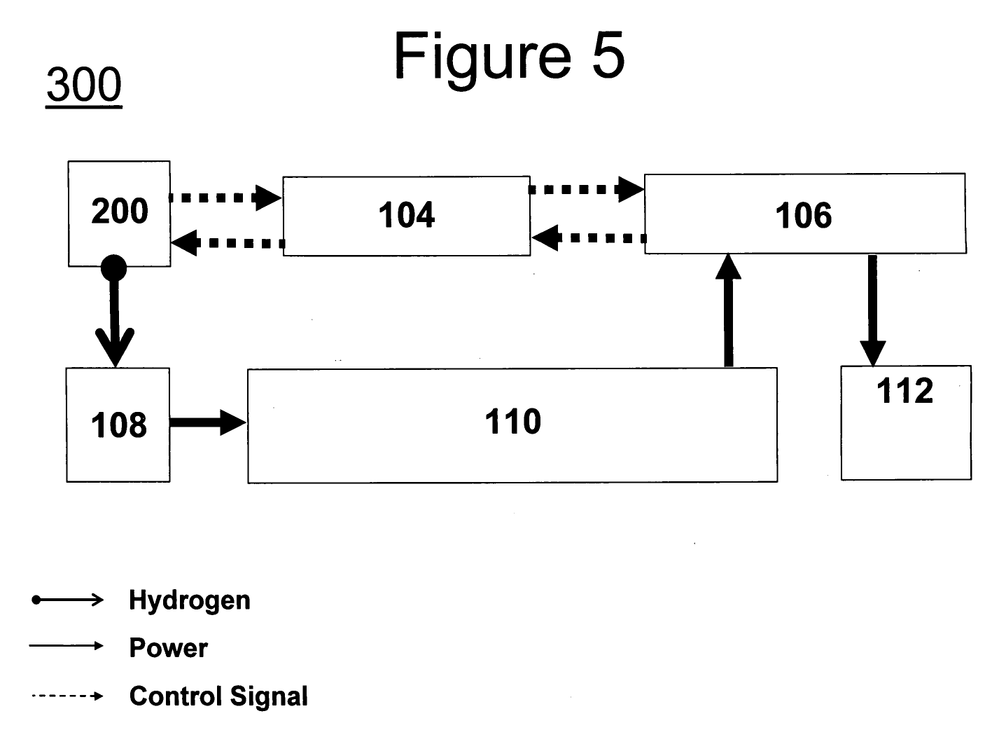

As shown in FIG. 5, an exemplary hybrid power system 300 according to this embodiment comprises a hydrogen generator 200, a hydrogen generator controller 104, a battery charging controller 106, a fuel cell 108, and a power conditioner 110. Typical controllers include microcontrollers, microprocessors, and any electronic feedback and control systems that can perform mathematical and logic operations. Typical power conditioners include dc/dc converters, dc/ac converters, and voltage regulators. In addition to controlling the hydrogen generator, controller 104 also communicates with charging controller 106 and provides information on the amount of battery capacity required to accommodate the hydrogen gas generated during shutdown. In addition to managing the state of charge, charging controller 106 communicates to controller 104 the hydrogen flow requirement to maintain the requested state of charge. Hydrogen gas is supplied by the hydrogen generator 200 to the fuel cell 108 for conversion to electrical power. A power conditioner 110 can be included in the power system to provide a constant voltage output. The battery 112 is also in electrical communication with the power conditioner 110 via charging control 106.

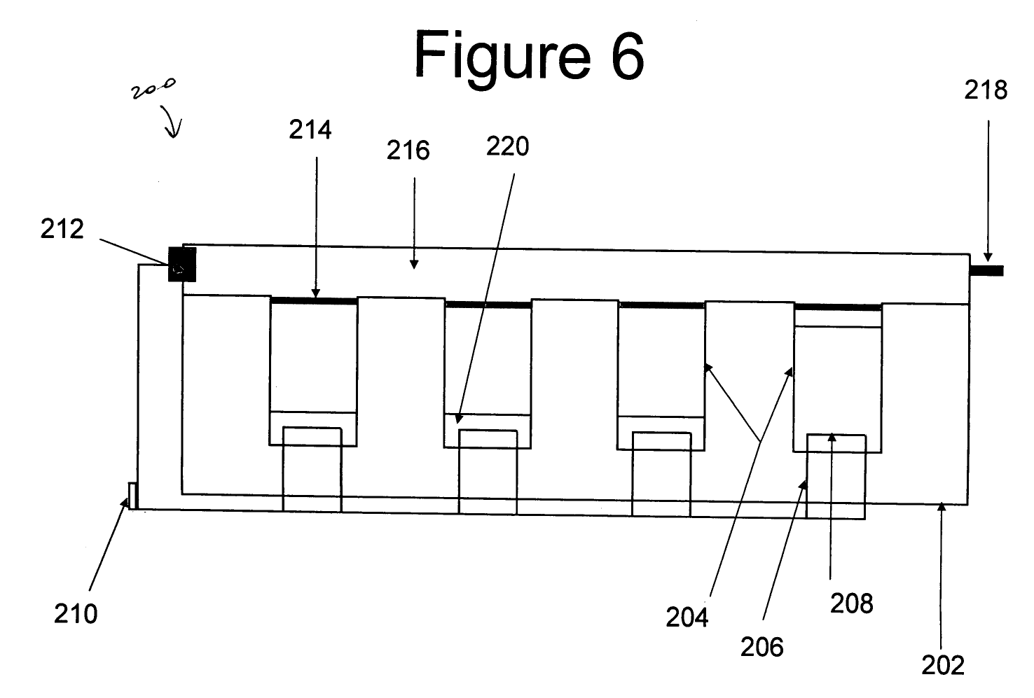

As shown in FIG. 6, hydrogen generator 200 comprises a fuel cartridge 202 with at least one reaction cell 204 which contains a fuel 220 which generates hydrogen when heated, a hydrogen chamber 216, a hydrogen gas outlet 218, and a pressure sensor 212. Each reaction cell 204 includes a heating element 208 in electrical communication via leads 206 with a heating controller (not illustrated) and is bounded by a gas permeable membrane 214. The cartridge 202 may include the heating controller or may have at least one electrical contact 210 that allows a removable cartridge to communicate with a controller in a power module comprising a fuel cell, for example. Preferably, the pressure sensor 212 is in electrical communication with the heating controller.

The fuel cell can use the hydrogen produced by the fuel 220 in reaction cells 204 directly, but if the rate of hydrogen generation exceeds that of hydrogen consumption, hydrogen pressure may increase within the fuel cartridge. This unconsumed hydrogen produced from the fuel 220 can be converted to electrical energy by the energy device and stored by the battery 112 to prevent pressure buildup in the fuel cartridge 202 and to store unused hydrogen for later use.

With reference to FIGS. 5 and 6, upon initial start, for example, the battery 112 can provide the electrical power to operate a connected electrical device. Once the battery 112 reaches a preset state of charge, the hydrogen generator 200 is signaled via control means 104 to begin hydrogen generation by heating at least one reaction cell 204 containing a fuel 220. The battery may also supply power for the heating elements 208 until it discharges to a preset state of charge while the fuel cell provides the primary power to operate the electronic device. The battery is available to provide power to handle peak loads for short durations, to compensate for transients in hydrogen generation, and/or to provide power for heating elements 208.

The following example further describes and demonstrates features of the present invention. This example is solely for illustration purposes and is not to be construed as a limitation of the present invention.

### EXAMPLE 1

A fuel cell power system was modeled to comprise a fuel cell, a lithium polymer rechargeable battery with 22 W charge rate capability, a hydrogen generator based on the reaction of sodium borohydride with aqueous sulfuric acid, a DC-DC converter, charging controller, and hydrogen generator controller, all integrated into a circuit board and connected to a laptop computer. The data simulation used actual data from hydrogen generated by the reaction of sodium borohydride with an acidic reagent as disclosed in co-pending U.S. patent application Ser. No. 11/105,549 and actual laptop usage data to calculate state of charge and pressure information. The fuel cell power was controlled to between about 0 W (e.g., “off”) to about 22 W.

On startup of the computer, the battery provided the electrical power until it reached about 85% state of charge. At this point, the fuel cell and hydrogen generating system were signaled to turn on and provide the primary power.

Hydrogen generation was stopped after approximately 95 minutes, and the hydrogen flow rate continued at a significant level beyond that time. The fuel cell was operated at a level that converted this excess hydrogen into electricity, which was used to charge the hybrid battery. During this “off” period, the system pressure did not significantly increase.

While the present invention has been described with respect to particular disclosed embodiments, it should be understood that numerous other embodiments are within the scope of the present invention. For instance, any suitable hydrogen gas generator and method may be used in combination with one or more auxiliary power systems, and may be selected by one of ordinary skill in the art given the teachings herein. Thus, while exemplary embodiments have been provided to illustrate the systems and methods of the present invention, they are not to be construed as limitations of the present invention.

What is claimed as new and desired to be protected by Letters Patent is:

1. A system for generating electrical power, comprising:
a hydrogen consuming device;
a hydrogen generator for generating hydrogen for use by the hydrogen consuming device;
an auxiliary power system capable of storing at least a portion of electricity produced by the hydrogen consuming device; and
a control system configured to activate the hydrogen generator depending on a charge state of the auxiliary power system.

2. The system of claim 1, wherein the hydrogen consuming device is a fuel cell.

3. The system of claim 1, wherein the hydrogen consuming device is a hydrogen combustion engine combined with an electrical generator.

4. The system of claim 1, wherein the auxiliary power system comprises an electrical storage device.

5. The system of claim 4, wherein the electrical storage device comprises a rechargeable battery.

6. The system of claim 1, wherein the auxiliary power system comprises a capacitor.

7. The system of claim 1, wherein the hydrogen generator is capable of forming hydrogen gas via reaction of a solid chemical hydride with an acidic reagent.

8. The system of claim 1, wherein the hydrogen generator is capable of forming hydrogen gas via heating a solid fuel comprising a chemical hydride.

9. The system of claim 1, wherein the auxiliary power system is configured to store electricity generated by the hydrogen consuming device.

10. The system of claim 2, wherein the fuel cell and the auxiliary power system are connected in parallel to an electric power consuming device.

11. The system of claim 1 further comprising a control system configured to activate a battery charging controller in response to changes in pressure.

12. An electrical power system for connection to a power consuming device, comprising:
a hydrogen gas generator;
a hydrogen consuming device;
an auxiliary power system configured to absorb excess electricity generated by the hydrogen consuming device; and
a control system configured to sense a state of charge of the auxiliary power system and to regulate the on/off state of the hydrogen gas generator to control the state of charge to a predetermined value;
wherein the auxiliary power system and the hydrogen consuming device are connected to the power consuming device in parallel.

13. The system of claim 12, wherein the hydrogen consuming device is a fuel cell.

14. The system of claim 12, wherein the hydrogen consuming device is a hydrogen combustion engine combined with an electrical generator.

15. The electrical power system of claim 12, wherein the auxiliary power system comprises a rechargeable battery.

16. The electrical power system of claim 12, wherein the auxiliary power system comprises a capacitor.

17. The electrical power system of claim 12, wherein the hydrogen generator is capable of generating hydrogen via heating a solid fuel comprising a chemical hydride.

18. The electrical power system of claim 12, wherein the hydrogen generator is capable of forming hydrogen gas via reaction of a solid chemical hydride with an acidic reagent.

19. The system of claim 12 further comprising a control system configured to activate a battery charging controller when the pressure of the system exceeds a predetermined value.

20. A method of controlling generation of hydrogen gas in a power system for connection to a power consuming device, wherein the power system includes a hydrogen gas generator, a fuel cell, and a rechargeable battery connected to the fuel cell, comprising:
monitoring the charge state of the rechargeable battery;
activating the hydrogen generator to supply hydrogen gas to the fuel cell when the charge state is below a predetermined value;
supplying electrical power to the power consuming device alternately from the rechargeable battery and the fuel cell; and
storing excess electrical energy produced by the fuel cell in the rechargeable battery.

21. The method of claim 20, further comprising deactivating the hydrogen generator when the charge state is above a predetermined value.

22. The method of claim 20, further comprising varying the rate of charge of the rechargeable battery.

23. The method of claim 20, further comprising:
providing electrical power from the rechargeable battery to the power consuming device;
providing a first signal to the hydrogen gas generator once the rechargeable battery discharges to reach a preset charge value; and
subsequently producing hydrogen gas in the hydrogen gas generator and supplying the hydrogen gas to the fuel cell to convert the hydrogen gas to electricity.

24. The method of claim 23, further comprising recharging the rechargeable battery with the hydrogen gas converted to electricity by the fuel cell.

25. The method of claim 20, wherein the hydrogen generator is capable of generating hydrogen by the reaction of a solid chemical hydride and an acidic reagent.

26. The method of claim 20, wherein the hydrogen generator is capable of generating hydrogen by heating a solid fuel comprising a chemical hydride.

27. The method of claim 20, further comprising regulating the charge state of the rechargeable battery to provide sufficient storage capacity to absorb electricity produced by excess hydrogen generation.

28. The method of claim 20, further comprising conditioning power output from the fuel cell and rechargeable battery to provide a constant voltage output.

29. The method of claim 20 further comprising regulating the pressure of the system by consuming hydrogen using a fuel cell to produce electricity to charge the rechargeable battery.
